(19) United States
(12) Patent Application Publication
(10) Pub. No.: US 2007/0159637 A1
(43) Pub. Date: Jul. 12, 2007

(54) Optical tomography system

(75) Inventor: Masahiro Toida, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/540,653

(22) Filed: Oct. 2, 2006

(30) Foreign Application Priority Data
Sep. 30, 2005 (JP) 289120/2005

(51) Int. Cl. G01B 9/02; G01J 3/45

(52) U.S. Cl. 356/456; 356/479

(57) ABSTRACT

In an optical tomography system, interference light is detected and a controller switches between a measurement initiating position adjusting mode and a tomographic image obtaining mode. The interference light is detected by an interference light detecting system including a spectral system which spectrally divides the interference light, a first optical system formed of a plurality of photo-sensors which detects the interference light by the wavelength band and a second optical system detecting a part interference light at a wavelength band which is a part of the whole wavelength band of the spectrally divided interference light in the measurement initiating position adjusting mode. The controller controls the interference light detecting system to detect the interference light with the first optical system in the image obtaining mode and with the second optical system in the measurement initiating position adjusting mode.

### BACKGROUND OF THE INVENTION

1. Field of the Invention

This invention relates to an optical tomography system for obtaining an optical tomographic image by measurement of OCT (optical coherence tomography).

2. Description of the Related Art

As a system for obtaining a tomographic image of an object of measurement in a body cavity, there has been known an ultrasonic tomography system. In addition to such an ultrasonic tomography system, there has been proposed an optical tomography system where an optical tomographic image is obtained on the basis of an interference of light by low coherence light. See, for instance, Japanese Unexamined Patent Publication No. 2003-172690. In the system disclosed in Japanese Unexamined Patent Publication No. 2003-172690, an optical tomographic image is obtained by measuring TD-OCT (time domain OCT) and the measuring light is guided into the body cavity by inserting a probe into the body cavity from the forceps port of an endoscope by way of a forceps channel.

More specifically, low coherence light emitted from a light source is divided into measuring light and reference light and the measuring light is projected onto the object of measurement, while the reflected light from the object of measurement is led to a multiplexing means. The reference light is led to the multiplexing means after its optical path length is changed. By the multiplexing means, the reflected light and the reference light are superposed one on another, and interference light due to the superposition is detected by, for instance, heterodyne detection. In the TD-OCT measurement, a phenomenon that interference light is detected when the optical path of the measuring light conforms to the optical path of the reference light in length is used and the measuring position (the depth of measurement) in the object is changed by changing the optical path length of the reference light.

When measuring the OCT by inserting a probe into a body cavity, the probe is mounted on the system body to be demountable since disinfection, cleaning and the like of the probe after use are necessary. That is, a plurality of probes are prepared for one optical tomography system and the probes are changed by the measurement. However there is an individual difference in the length of the optical fiber due to the manufacturing errors and the like, and the optical path length of the measuring light can change each time the probe is changed. Accordingly, in Japanese Unexamined Patent Publication No. 2003-172690, on the basis of the reflected light from the inner surface of a tube (sheath) covering an optical fiber of the probe, the optical path length of the reference light is adjusted to conform to the optical path length of the measuring light.

Whereas, as a system for rapidly obtaining a tomographic image without changing the optical path length of the reference light such as disclosed in Japanese Unexamined Patent Publication No. 2003-172690, there have been proposed optical tomography systems of obtaining an optical tomographic image by spatially or time dividing the interference light (See, for instance, United States Patent 5,565,986 or Japanese Unexamined Patent Publication No. 11 (1999)-082817). Among those, a SD-OCT (source domain OCT) system where the frequency of light emitted from a light source is spatially divided to detect the interference light altogether has been proposed. In the SD-OCT system, a tomographic image is formed without scanning in the direction of depth, by emitting broad band, low coherence light from a light source by the use of a Michelson interferometer, dividing the low coherence light into measuring light and reference light and carrying out a Fourier analysis on each signal of channeled spectrum obtained by decomposing the interference light of the reflected light, which returns when projecting the measuring light onto the object, and the reference light into frequency components.

### SUMMARY OF THE INVENTION

In the SD-OCT measurement, it is not necessary to conform the optical path length of the measuring light to that of the reference light since information on the reflection in positions in the direction of depth can be obtained by carrying out frequency-analysis. However, actually, there arises a problem that when the optical path length difference becomes large, the spatial frequency of the interference signal is enlarged and the S/N of the detected interference signal deteriorates due to the sampling time or the maximum spatial frequency of the CCDs or the photodiodes for detecting the interference light. Accordingly, also in the SD-OCT measurement, it is still necessary to adjust the optical path length so that the optical path length of the measuring light conforms to that of the reference light.

Further since the measurable range over which a tomographic image is obtainable by the SD-OCT measurement is limited in the direction of depth, it is necessary to adjust the optical path length of the reference light according to the distance between the probe and the object in order to adjust the measurement initiating position so that the object S is positioned in the measurable range. That is, in the SD-OCT measurement, it is necessary to adjust the measurement initiating position so that the object S is positioned in the measurable range in addition to that the optical path length must be adjusted in order to accommodate the individual difference of the probe such as shown in Japanese Unexamined Patent Publication No. 2003-172690.

Since in the TD-OCT measurement, the measuring depth is changed by adjusting the optical path length of the reference light, the measurable range can be adjusted by adjusting the optical path length while observing the intensities or the waveforms of the signals obtained by a beat signal measurement or the interferogram measurement of the interference light. However, since in the SD-OCT measurement, the reflection information cannot be obtained unless frequency-analysis such as Fourier-transform is carried out on the detected interference light and when the position of the object is confirmed to adjust the measurement initiating position, frequency-analysis is required, it takes a long time to adjust the measurement initiating position.

In view of the foregoing observations and description, the primary object of the present invention is to provide an optical tomography system in which the adjustment of the measurement initiating position can be carried out in a short time.

In accordance with the present invention, there is provided an optical tomography system for obtaining a tomographic image of an object to be measured comprising

a light source unit which emits low coherence light,

a light dividing means which divides the low coherence light emitted from the light source unit into measuring light and reference light,

an optical path length adjusting means which adjusts the optical path length of the measuring light or the reference light divided by the light dividing means,

a multiplexing means which multiplexes the reflected light from the object when the measuring light is projected onto the object and the reference light,

an interference light detecting means which detects interference light of the reflected light and the reference light which have been multiplexed by the multiplexing means, and

a tomographic image obtaining means which obtains a tomographic image of the object by carrying out frequency-analysis on the interference light detected by the interference light detecting means, and

a control means which switches between a measurement initiating position adjusting mode in which the position in the direction of depth of the object in which tomographic image signal is to be obtained is adjusted and a tomographic image obtaining mode in which a tomographic image of the object is to be obtained,

wherein the improvement comprises that

the interference light detecting means comprises a spectral means which spectrally divides the interference light, a first optical detecting means comprising a plurality of photo-sensors which detects the interference light by the wavelength band which is spectrally divided by the spectral means in the image obtaining mode, and a second optical detecting means which detects a part interference light at a wavelength band which is a part of the whole wavelength band of the interference light spectrally divided by the spectral means in the measurement initiating position adjusting mode, and the control means controls the interference light detecting means to detect the interference light with the first optical detecting means in the image obtaining mode and with the second optical detecting means in the measurement initiating position adjusting mode.

The second optical detecting means may be of any arrangement so long as it detects interference light at a wavelength band which is a part of the whole wavelength band. The second optical detecting means may be formed separately from the first optical detecting means, or may comprise a part of a plurality of the photo-sensors forming the first optical detecting means.

Further, the control means may have a function, in addition to the function of controlling the interference light detecting means according to the mode, of automatically controlling the optical path length adjusting means so that the optical path length difference between the reference light and the measuring light is in an interference light generating region. The “interference light generating region” means a region where the optical path length difference between the measuring light and the reference light is smaller than the coherence length and interference can occur.

Further, the interference light detecting means may detect an interference light by a second low coherence light as interferogram or a beat signal in the measurement initiating position adjusting mode. When the interference light detecting means detects the interference light by the second low coherence light, a phase modulation means which gives a frequency difference between the measuring light and the reference light is provided and the control means drives the phase modulation means in the image obtaining mode.

In accordance with the optical tomography system of the present invention, since the interference light detecting means is provided with a first optical detecting means comprising a plurality of photo-sensors which detects the interference light by the wavelength band which is spectrally divided by the spectral means in the image obtaining mode, and a second optical detecting means which detects a part interference light at a wavelength band which is a part of the whole wavelength band spectrally divided by the spectral means in the measurement initiating position adjusting mode, and the control means controls the interference light detecting means to detect the interference light with the first optical detecting means in the image obtaining mode and with the second optical detecting means in the measurement initiating position adjusting mode, the time required in the signal processing on the interference light in order to detect the measurement initiating position can be shortened and the adjustment of the measurement initiating position can be carried out in short time by carrying out a so-called TD-OCT measurement by the use of the interference light detected by the second optical detecting means and obtains a tomographic image to determine the position of the object when setting the measurement initiating position from which a tomographic image is to be obtained in the measurement initiating position adjusting mode.

When the control means controls the optical path length adjusting means so that the optical path length difference between the reference light and the measuring light is in an interference light generating region in the measurement initiating position adjusting mode, the optical path length can be automatically carried out, whereby the tomographic image signal can be efficiently obtained and the measurement initiating position can be surely adjusted.

When the second optical detecting means comprises a part of a plurality of the photo-sensors forming the first optical detecting means, the second optical detecting means need not be separately provided and the system can be simplified.

When a phase modulation means which gives a frequency difference between the measuring light and the reference light is further provided and the control means drives the phase modulation means in the image obtaining mode, the interference light detecting means can detect the interference light as a beat signal that varies in intensity at the frequency difference, whereby the time required for adjustment of the measurement initiating position can be further shortened.

### BRIEF DESCRIPTION OF THE DRAWINGS

FIG. 1 is a schematic diagram showing an optical tomography system in accordance with a preferred embodiment of the present invention,

FIG. 2 is a schematic diagram showing an optical tomography system in accordance with a second embodiment of the present invention,

FIG. 3 is a schematic diagram showing an optical tomography system in accordance with another embodiment of the present invention, and

FIG. 4 is a schematic diagram showing an optical tomography system in accordance with still another embodiment of the present invention.

### DESCRIPTION OF THE PREFERRED EMBODIMENTS

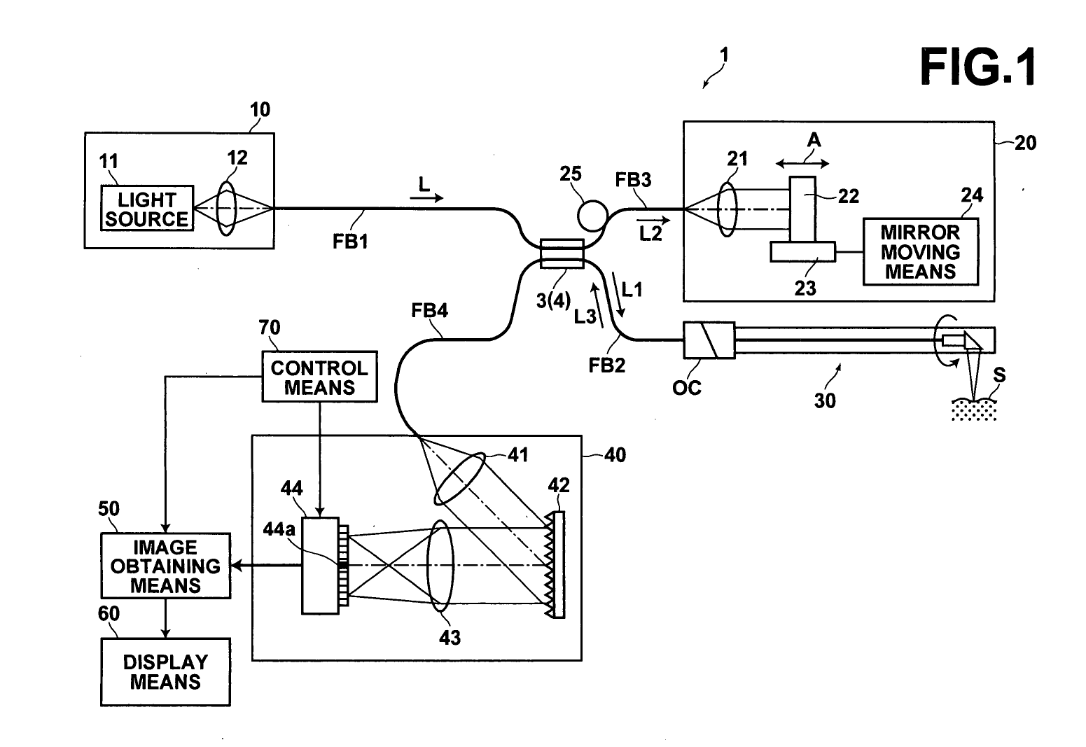

Embodiments of the optical tomography system of the present invention will be described in detail with reference to the drawings, hereinbelow. FIG. 1 is a schematic diagram that illustrates an optical tomography system in accordance with a preferred embodiment of the present invention. The optical tomography system 1 of this embodiment is for obtaining a tomographic image of an object of measurement such as a living tissue or a cell in a body cavity by measuring the SD-OCT. The optical tomography system 1 of this embodiment comprises: a light source unit 10 for emitting a low coherence light beam L; a light dividing means 3 for dividing the light beam L emitted from the light source unit 10 into a measuring light beam L1 and a reference light beam L2; an optical path length adjusting means 20 for adjusting the optical path length of the reference light beam L2 divided by the light dividing means 3; a probe 30 which guides to the object S to be measured the measuring light beam L1 divided by the light dividing means 3; a multiplexing means 4 for multiplexing a reflected light beam L3 from the object S when the measuring light beam L1 is irradiated onto the object S from the probe 30, and the reference light beam L2; an interference light detecting means 40 for detecting interference light beam L4 of the reflected light beam L3 and the reference light beam L2 which have been multiplexed and an image obtaining means 50 which obtains a tomographic image of the object S by carrying out frequency-analysis on the interference light beam L4 detected by the interference light detecting means 40.

The light source unit 10 comprises a light source 11 which emits low coherence light beam such as SLD (super luminescent diode) or ASE (amplified spontaneous emission) and an optical system 12 for entering the light beam emitted from the light source 111 into an optical fiber FB1. Since the optical tomography system 1 is for obtaining a tomographic image of an organic body in a body cavity of the object S, it is preferred that the light source unit emits a broad spectral band, ultra short pulse light beam where attenuation of light beam due to scatter and/or absorption when transmitted through the object S is minimized.

The light dividing means 3 comprises, for instance, a 2×2 fiber optic coupler and divides the light beam L led thereto by way of the optical fiber FB1 from the light source unit 10 into the measuring light beam L1 and the reference light beam L2. The light dividing means 3 is optically connected to two optical fibers FB2 and FB3, and the measuring light beam L1 is propagated through the optical fiber FB2 while the reference light beam L2 is propagated through the optical fiber FB3. In FIG. 1, the light dividing means 3 also functions as the multiplexing means 4.

The probe 30 is optically connected to the optical fiber FB2 and the measuring light beam L1 is guided to the probe 30 from the optical fiber FB2. The probe 30 is inserted into a body cavity, for instance, through a forceps port by way of a forceps channel and is removably mounted on the optical fiber FB2 by an optical connector OC.

The optical path length adjusting means 20 is disposed on the side of the optical fiber FB3 radiating the reference light beam L2. The optical path length adjusting means 20 changes the optical path length of the reference light beam L2 in order to adjust the measurement initiation position with respect to the object S and comprises a collimator lens 22 and a reflecting mirror 22. The reference light beam L2 radiated from the optical fiber FB3 is reflected by the reflecting mirror 22 after passing through the collimator lens 22 and reenters the optical fiber FB3 again through the collimator lens 21.

The reflecting mirror 22 is disposed on a movable stage 23 which is moved in the direction of arrow A by a mirror moving means 24. In response to movement of the movable stage 23 in the direction of arrow A, the optical path length of the reference light beam L2 is changed.

The multiplexing means 4 comprises a 2×2 fiber optic coupler, and multiplexes the reference light beam L2 which has been changed in its optical path length and shifted in its frequency by the optical path length adjusting means 20 and the reflected light beam L3 from the object S to emit the multiplexed light beam toward an interference light detecting means 40 by way of an optical fiber FB4.

The interference light detecting means 40 detects interference light beam L4 of the reflected light beam L3 and the reference light beam L2 which have been multiplexed by the multiplexing means 4 and comprises a spectral means 42 which spectrally divides the interference light beam L4 having a predetermined wavelength band by the wavelength band, a first light detecting means 44 which detects the amount of light by the wavelengths of the interference light beam L4 divided by the spectral means 42, and a lens 43 which is disposed between the first light detecting means 44 and the spectral means 42 and has a function of imaging the interference light beam L4 spectrally divided by the spectral means 42 on the light detecting means 44.

The spectral means 42 comprises, for instance, a diffraction grating element, and divides the interference light beam L4 entering it from an optical fiber FB4 by way of a collimator lens 41 to emit the divided interference light beam L4 to the first light detecting means 44. The lens 43 collects the divided interference light beam L4 divided by the spectral means 42 on the light detecting means 44. The first light detecting means 44 comprises an optical sensor 47 which comprises a plurality of one-dimensionally arranged photo-sensors 46 such as CCDs or photodiodes and the photo-sensors 46 detects the interference light beam L4 impinging thereupon by way of the lens 43 by the wavelength band.

The image obtaining means 50 may obtain information on reflection of the positions in the direction of depth of the object S by carrying out frequency analysis on the interference light beam L4 detected by the interference light detecting means 40. The image obtaining means 50 obtains an image of the object S by using the intensities of the reflected light beam L3 in positions in the direction of depth of the object S. Then the tomographic image is displayed in a display 60.

Here, detection of the interference light beam L4 in the interference light detecting means 40 and image generation in the image obtaining means 50 will be described briefly. Note that a detailed description of these two points can be found in M. Takeda, “Optical Frequency Scanning Interference Microscopes”, Optical Engineering Contact, Vol. 41, No. 7, pp. 426-432, 2003.

When the measuring light beam L1 having a spectral intensity distribution of S(k), the light intensity I(k) detected in the interference light detecting means 40 as the interferogram is expressed by the following formula.

$$I ( I ) = {\int }_{0}^{∞} S ( k ) [ l + cos ( kl ) ] ⅆ k \qquad ( 1 )$$

wherein k represents the angular frequency and l represents the optical path length difference between the measuring light beam L1 and the reference light beam L2. Formula (1) expresses how much components of the angular frequency k of the interference fringe I(I) are included in the interference fringe I(I) where the spectral intensity distribution of each spectral component is S(k). Further, from the angular frequency k of the interference light fringes, the optical path length difference between the measuring light beam L1 and the reference light beam L2, that is, information on the position of depth, is given. Accordingly, S(k) of the interference light beam L4 can be obtained by carrying out frequency analysis by Fourier-transform on the interferogram detected by the interference light detecting means 40 in the image obtaining means 50. Then a tomographic image is generated by obtaining information on the distance of the object S from the measurement initiating position and information on the intensity of reflection. The generated tomographic image is displayed in the display 60.

Operation of the optical tomography system 1 will be described with reference to FIG. 1, hereinbelow. When a tomographic image is to be obtained, the optical path length is first adjusted by moving the movable stage 23 in the direction of the arrow A so that the object S is positioned in the measurable area. The low coherence light beam L is subsequently emitted from the light source unit 10 and the low coherence light beam L is divided into the measuring light beam L1 and the reference light beam L2 by the light dividing means 3. The measuring light beam L1 is led by the optical probe 30 into a body cavity and is projected onto the object S. Then the reflected light beam L3 from the object S and the reference light beam L2 reflected by the reflecting mirror 22 are multiplexed, and the interference light beam L4 of the reflected light beam L3 and the reference light beam L2 is detected by the interference light detecting means 40. A tomographic image is obtained by carrying out frequency analysis on a signal of the detected interference light beam L4 in the image obtaining means 50. In the optical tomography system 1 where a tomographic image is obtained by the SD-OCT measurement, the image information in positions in the direction of depth is obtained on the basis of the frequency and the intensity of the interference light beam L4 and the movement of the reflecting mirror 22 in the direction of arrow A is used for adjustment of the position in which a tomographic image is to be obtained in the direction of depth of the object S.

In the case where the measurement initiating position is adjusted by moving the reflecting mirror 22 in the arrow A, steps of first moving the reflecting mirror, carrying out detection of the reflected light beam L4 when the reflecting mirror 22 is in the position and signal processing such as frequency-analysis on the detected reflected light beam L4, and thereafter readjusting the position of the reflected mirror is necessary. That is, what kind of interference light beam is detected in the new position of the reflecting mirror cannot be known until the signal processing is carried out, whereby adjustment of the measurement initiating position requires a long time.

Accordingly, in the optical tomography system of FIG. 1, there is provided a control means 70 which switches between a measurement initiating position adjusting mode where the position in which a tomographic image is to be obtained is adjusted in the direction of depth of the object S and an image obtaining mode where an image of the object S is obtained so that the system is switched to the image obtaining mode after the position in which a tomographic image is to be obtained is adjusted in the measurement initiating position adjusting mode and a tomographic image is obtained.

A phase modulating means 25 such as a piezoelectric element which shifts the frequency of the reference light beam L2 is provided in the optical fiber FB3 and the control means 70 drives the phase modulating means 25 in the measurement initiating position adjusting mode. Then the control means 70 controls the interference light detecting means 40 to carry out the TD-OCT measurement, where the measuring depth changes in response to movement of the reflecting mirror 22, by the use of the low coherence light L emitted from the light source unit 10. At this time, the centrally disposed ones 44 a of a plurality of the photo-sensors forming the first light detecting means 44 function as a second light detecting means. A tomographic image is obtained by the image obtaining means 50 by the use of the interference light beam L4 detected by theses photo-sensors 44a.

That is, the control means 70 controls so that these photo-sensors 44a and the image obtaining means 50 detect the interference light beam L4 by heterodyne detection. The low coherence light beam L emitted from the light source unit 10 is divided into the measuring light beam L1 and the reference light beam L2 by the light dividing means 3, and the reflected light beam L3 from the object S is multiplexed with the reference light beam L2 by the multiplexing means 4 to generate the interference light beam L4. At this time, the reflecting mirror 22 of the optical path length adjusting means 22 is moved in the direction of arrow A to change the optical path length of the reference light beam L2.

In the photo-sensors 44a of the interference light detecting means 40, a beat signal which repeats strength and weakness at the frequency difference between the reflected light beam L3 and the reference light beam L2 is detected as an interference light beam L4 when the optical path lengths of the measuring light beam L1 and the reference light beam L2 are equal to each other. As the optical path length is changed by the optical path length adjusting means 20, the optical path length between the measuring light beam and the reference light beam changes and when the optical path lengths of the measuring light beam and the reference beam light come to conform to each other, the second light detecting means 44a detects a beat signal. Accordingly, the measurement initiating position is adjusted by adjusting position of the reflecting mirror 22 in the optical path length adjusting means 20.

The optical path length adjusting means 20 may be arranged to cause the control means to automatically adjust the optical path length at this time. At this time, the optical path length adjusting means 20 is controlled so that the optical path length difference between the reference light beam L2 and the measuring light beam L1 is in an interference light generating region. The “interference light generating region” means a region where such an interference that the optical path length difference Δ1 between the measuring light beam L1 and the reference light beam L2 is smaller than the coherence length takes place.

After the adjustment of the measurement initiating position, the control means 70 switches from the measurement initiating position adjusting mode to the image obtaining mode and a tomographic image is obtained. At this time, the control means 70 controls so that the wavelength-fluctuating low coherence light beam L is emitted from the light source unit 10 and the interference light detecting means 40 and the image obtaining means 50 detect the interference light L4 on which the reflection information in the positions in the direction of depth is superposed. Then the image obtaining means 50 obtains a tomographic image on the basis of the interference light beam L4 detected by the interference light detecting means 40.

By the SD-OCT measurement, where it is not necessary to move the reflecting mirror 22, a tomographic image can be obtained at a higher speed than by the TD-OCT measurement. However, the TD-OCT measurement is wider than the SD-OCT measurement in the measurable range. On the other hand, the tomographic image need not be of a high resolution when the measurement initiating position is adjusted. Accordingly, by obtaining tomographic images by the SD-OCT measurement and detecting the object to adjust the optical path length by the TD-OCT measurement in the measurement initiating position adjusting mode, the object S can be easily imaged in a tomographic image and the signal processing can be effected in a short time, whereby the optical path length can be adjusted simply at high speed.

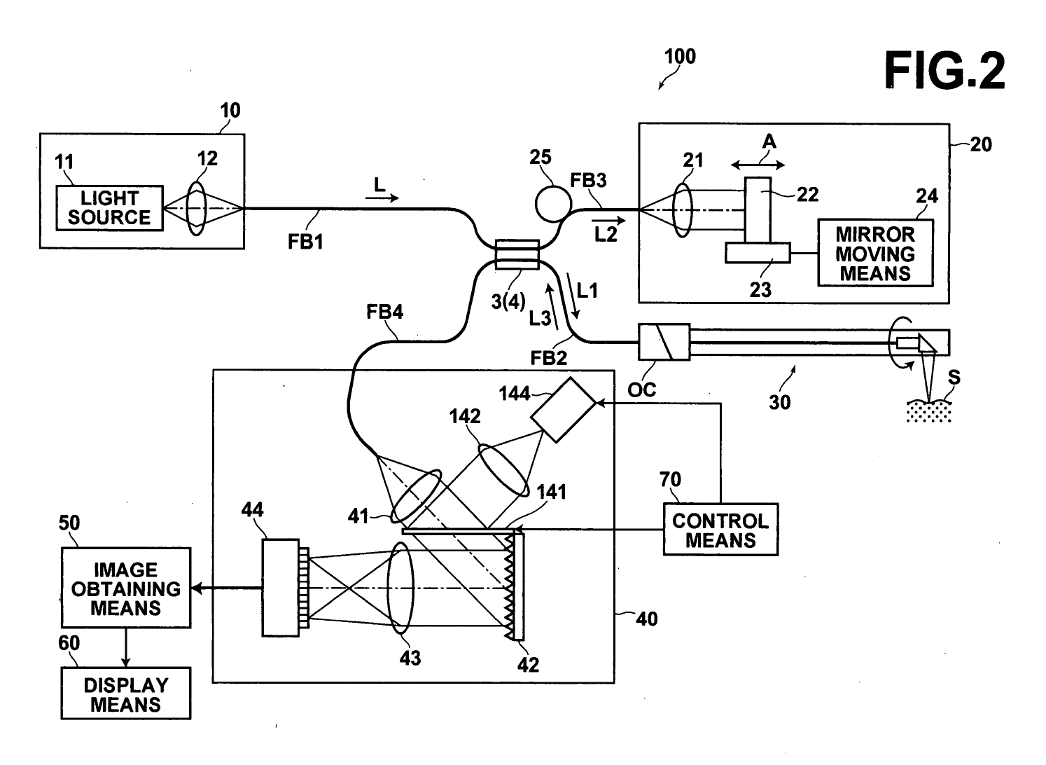

FIG. 2 is a schematic diagram of an optical tomography system in accordance with a second embodiment of the present invention, and the optical tomography system 100 will be described with reference to FIG. 2, hereinbelow. In FIG. 2, the elements analogous to those in the optical tomography system 1 of FIG. 1 are given the same reference numerals and will not be described here.

The optical tomography system 100 of FIG. 2 differs from the optical tomography system 1 of FIG. 1 in structure of the second light detecting means. That is, in FIG. 2, the second light detecting means 144 is provided separately from the first light detecting means 44 and the TD-OCT measurement is carried out on the basis of the interference light L4 detected by the second light detecting means 144 in the measurement initiating position adjusting mode. In order to guide the interference light beam L4 to the second light detecting means 144, a mirror 141 which reflects toward the second light detecting means 144 the interference light beam L4 passing through the collimator lens 41 and a collecting lens 142 which collects the interference light beam L4 reflected by the mirror 141 on the second light detecting means 144 are disposed. The control means 70 inserts the mirror 141 between the collimator lens 41 and the spectral means 42 only in the measurement initiating position adjusting mode, and removes mirror 141 in the image obtaining mode.

Even in this case, the object is detected by the TD-OCT measurement in the measurement initiating position adjusting mode to adjust the optical path length, whereby the signal processing can be effected in a short time, and the optical path length can be adjusted simply at high speed.

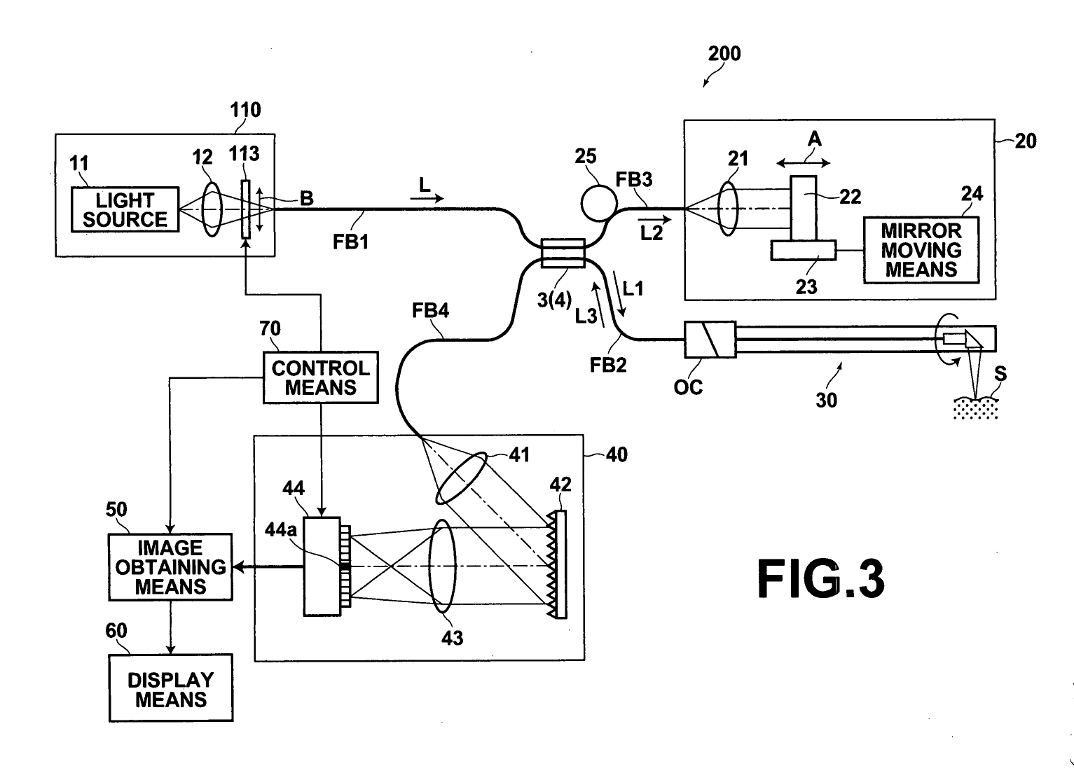

Though in the above embodiments, the low coherence light beam L which is the same in the wavelength band in the image obtaining mode and the measurement initiating position adjusting mode is used, a band pass filter may be provided to narrow the wavelength band of the low coherence light beam L only in the measurement initiating position adjusting mode as shown in FIG. 3.

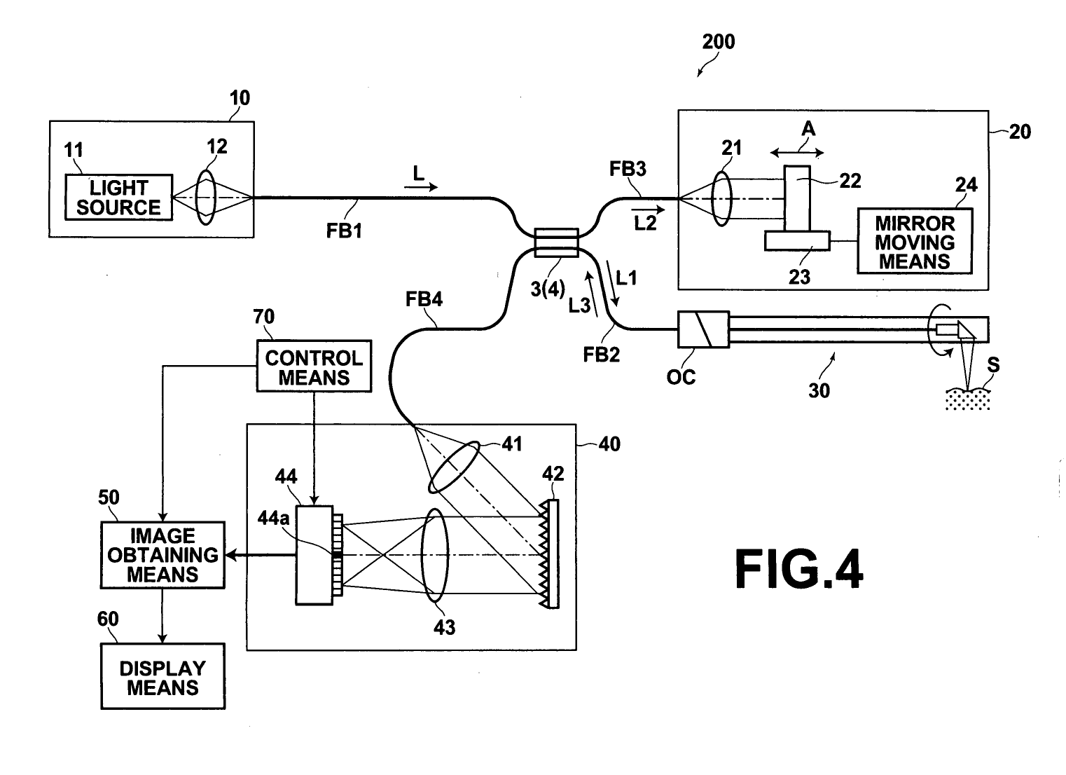

Though, in the measurement initiating position adjusting mode of the above embodiments, the interference light beam L4 of the low coherence light is detected as the beat signal, the interference light beam L4 may be detected as an interferogram by not providing the phase modulating means 25 in the optical path of the reference light beam L2 (e.g., the optical fiber FB3) as shown in FIG. 4.

Further, though the optical path length adjusting means 20 adjusts the optical path length of the reference light beam L2 in FIG. 1, the optical path length adjusting means 20 may adjust the optical path length of the measuring light beam L. In this case, the above said optical path length adjusting means 20 is interposed, for instance, in the optical fiber FB2 for guiding the measuring light beam L1 and the mirror in the optical fiber FB3 is fixed.

In accordance with the above embodiments, since the interference light detecting means 40 comprises a spectral means 42 which spectrally divides the interference light beam L4, a first light detecting means 44 comprising a plurality of photo-sensors which detects the interference light beam L4 divided by the spectral means 42 in the image obtaining mode, and a second light detecting means 44a (144) which detects a part interference light at a wavelength band which is a part of the whole wavelength band of the interference light beam L4 spectrally divided by the spectral means 42 in the measurement initiating position adjusting mode, and the control means 70 controls the interference light detecting means 40 and the image obtaining means 50 to detect the interference light with the first optical detecting means 44 in the image obtaining mode and to detect the interference light different in the positions in the direction of depth in the object due to adjustment of the optical path length by the optical path length adjusting means with the second optical detecting means 44a (144) in the measurement initiating position adjusting mode, tomographic images are obtained to identify the position of the object by a so-called TD-OCT measurement by the use of the interference light L4 detected by the second light detecting means 44a when the measurement initiating position for obtaining a tomographic image in the measurement initiating position adjusting mode is set, whereby the time required to carry out signal processing on the interference light in order to detect the measurement initiating position is shortened and the measurement initiating position can be adjusted in a short time.

What is claimed is:

1. An optical tomography system for obtaining a tomographic image of an object to be measured comprising
a light source unit which emits low coherence light,
a light dividing means which divides the low coherence light emitted from the light source unit into measuring light and reference light,
an optical path length adjusting means which adjusts the optical path length of the measuring light or the reference light divided by the light dividing means,
a multiplexing means which multiplexes the reflected light from the object when the measuring light is projected onto the object and the reference light,
an interference light detecting means which detects interference light of the reflected light and the reference light which have been multiplexed by the multiplexing means, and
a tomographic image obtaining means which obtains a tomographic image of the object by carrying out frequency-analysis on the interference light detected by the interference light detecting means, and
a control means which switches between a measurement initiating position adjusting mode in which the position in the direction of depth of the object in which tomographic image signal is to be obtained is adjusted and a tomographic image obtaining mode in which a tomographic image of the object is to be obtained,
the interference light detecting means comprising a spectral means which spectrally divides the interference light, a first optical detecting means comprising a plurality of photo-sensors which detects the interference light by the wavelength band which is spectrally divided by the spectral means in the image obtaining mode, and a second optical detecting means which detects a part interference light at a wavelength band which is a part of the whole wavelength band of the interference light spectrally divided by the spectral means in the measurement initiating position adjusting mode, and
the control means controlling the interference light detecting means to detect the interference light with the first optical detecting means in the image obtaining mode and with the second optical detecting means in the measurement initiating position adjusting mode.

2. An optical tomography system as defined in claim 1 in which the control means controls the optical path length adjusting means so that the optical path length difference between the reference light and the measuring light is in an interference light generating region.

3. An optical tomography system as defined in claim 1 in which the second optical detecting means comprises a part of a plurality of the photo-sensors forming the first optical detecting means.

4. An optical tomography system as defined in claim 1 further comprising a phase modulation means which gives a frequency difference between the measuring light and the reference light in which the control means drives the phase modulation means in the image obtaining mode.
